(19) United States
(12) Patent Application Publication
(10) Pub. No.: US 2015/0141074 A1
(43) Pub. Date: May 21, 2015

(54) FOLDABLE CALLING DEVICE

(71) Applicant: Samsung Display Co., Ltd., Yongin-City (KR)

(72) Inventors: Jin-Bo Shim, Yongin-City (KR); Yoon-Jee Shin, Yongin-City (KR); Seung-Rok Lee, Yongin-City (KR); Won-Suk Choi, Yongin-City (KR)

(73) Assignee: Samsung Display Co., Ltd., Yongin-City (KR)

(21) Appl. No.: 14/195,098

(22) Filed: Mar. 3, 2014

(30) Foreign Application Priority Data
Nov. 19, 2013 (KR) 10-2013-0140898

(51) Int. Cl. H04M 1/02

(52) U.S. Cl. CPC H04M 1/0216; H04M 1/0264
USPC 455/556.1; 455/575.3

(57) ABSTRACT

A foldable calling device includes a body which is foldable; a speaker at a first side of the body, in an unfolded state of the body; a first microphone at the first side of the body, in the unfolded state of the body; and a second microphone at a second side of the body opposite to the first side, in the unfolded state of the body.

This application claims priority to Korean Patent Application No. 10-2013-0140898, filed on Nov. 19, 2013, and all the benefits accruing therefrom under 35 U.S.C. §119, the disclosure of which is incorporated herein in its entirety by reference.

### BACKGROUND

1. Field

One or more exemplary embodiment of the invention relates to a calling device which may be folded and unfolded.

2. Description of the Related Art

Calling devices, such as cellular phones, include a microphone and a speaker so that a person may have a phone conversation with another person, by sending audio signals using the microphone, and by listening to audio signals from the other person by using the speaker.

### SUMMARY

One or more exemplary embodiment of the invention includes a foldable calling device.

According to one or more exemplary embodiment of the invention, a foldable calling device includes a body which is foldable; a speaker at a first side of the body, in an unfolded state of the body; a first microphone at the first side of the body, in the unfolded state of the body; and a second microphone at a second side of the body opposite to the first side, in the unfolded state of the body.

The first microphone may face the speaker when the body is in a folded state.

The second microphone may be disposed such that a direction that the second microphone is facing forms 90° or less with respect to a direction that the speaker is facing when the body is folded.

The first microphone may be in an on state when the body is in the unfolded state, and the second microphone may be in an on state when the body is in a folded state.

A first camera at the first side of the body, and a second camera at the second side of the body, may be further included.

The first microphone may be in an on state when the first camera is in an on state, and the second microphone may be in an on state when the second camera is in an on state.

The body may include a flexible display panel including a display unit.

The speaker may be at an upper portion of the display unit, and the first microphone may be at a lower portion of the display unit, in the unfolded state of the body.

### BRIEF DESCRIPTION OF THE DRAWINGS

These and/or other features will become apparent and more readily appreciated from the following description of the exemplary embodiments, taken in conjunction with the accompanying drawings in which:

FIG. 1 is a perspective view of an exemplary embodiment of a foldable calling device, according to the invention;

FIGS. 2A and 2B are respective plan views of a front side and a back side of the foldable calling device of FIG. 1, in an unfolded state thereof;

FIG. 3 is a view of a folded state of the foldable calling device of FIG. 1;

FIG. 4A is a view of performing photography by using a first camera of the foldable calling device of FIG. 1; and

FIG. 4B is a view of performing photography by using a second camera of the foldable calling device of FIG. 1.

### DETAILED DESCRIPTION

Reference will now be made in detail to exemplary embodiments, examples of which are illustrated in the accompanying drawings, wherein like reference numerals refer to like elements throughout. In this regard, the exemplary embodiments may have different forms and should not be construed as being limited to the descriptions set forth herein. Accordingly, the exemplary embodiments are merely described below, by referring to the figures, to explain features of the invention.

As used herein, the singular forms “a,” “an” and “the” are intended to include the plural forms as well, unless the context clearly indicates otherwise.

It will be further understood that the terms “comprises” and/or “comprising” used herein specify the presence of stated features or components, but do not preclude the presence or addition of one or more other features or components.

It will be understood that when a layer, region, or component is referred to as being “on,” another layer, region, or component, it can be directly or indirectly on the other layer, region, or component. That is, for example, intervening layers, regions, or components may be present. As used herein, the term “and/or” includes any and all combinations of one or more of the associated listed items.

Sizes of elements in the drawings may be exaggerated for convenience of explanation. In other words, since sizes and thicknesses of components in the drawings are arbitrarily illustrated for convenience of explanation, the following exemplary embodiments are not limited thereto.

When a certain exemplary embodiment may be implemented differently, a specific process order may be performed differently from the described order. For example, two consecutively described processes may be performed substantially at the same time or performed in an order opposite to the described order.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “lower,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “above” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the invention will be described in detail with reference to the accompanying drawings.

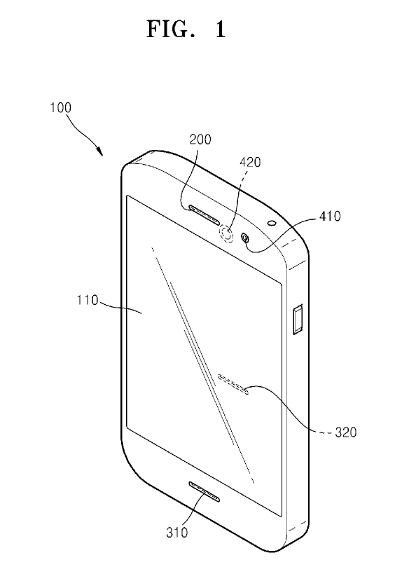

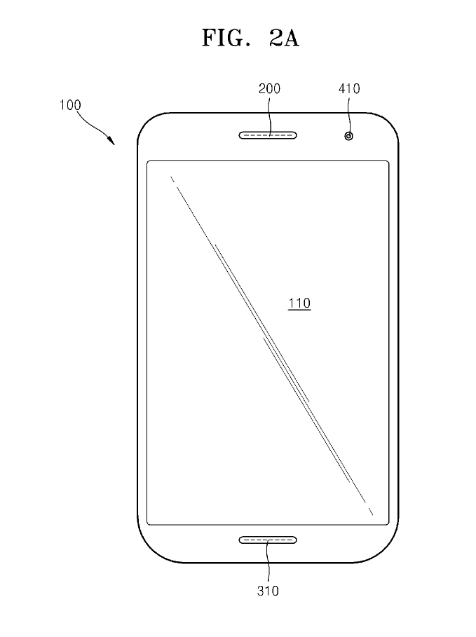

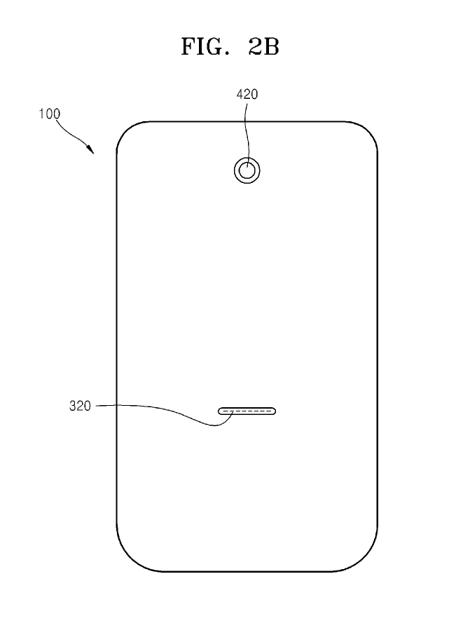

FIGS. 1, 2A, and 2B illustrate an exemplary embodiment of a foldable calling device, according to the invention.

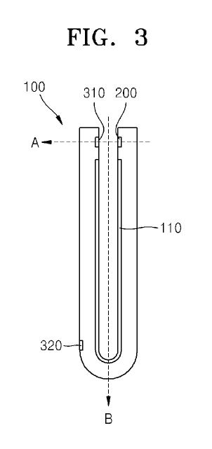

A body 100 of the foldable calling device includes a flexible display panel so that the body 100 may be folded (e.g., in half) (refer to FIG. 3).

In general, the flexible display panel has a structure including a thin film transistor (“TFT”) and light-emitting diodes (“LEDs”) for imaging stacked on a flexible substrate, and an encapsulating layer for covering and protecting the TFT and the LEDs on the flexible substrate. Since the flexible substrate is used in the flexible display panel instead of a rigid or hard glass substrate, the body 100 may be folded and unfolded freely inasmuch as the flexibility of the flexible substrate allows. Reference numeral 110 indicates a display unit of the flexible display panel displaying an image. Hereinafter, one side of the body 100 that shows (e.g., exposes) the display unit 110 is referred to as “a side” and the opposite side of the side is referred to as “the other side” of the body 100.

As illustrated in FIGS. 1 and 2A, a speaker 200 and a first microphone 310 employed by a user to call another person are respectively provided on an upper portion and a lower portion of the display unit 110 on the side of the body 100. Therefore, when the body 100 is unfolded, the user may have a phone conversation with the other person by using the speaker 200 and the first microphone 310. In an unfolded state of the body 100, as shown in FIG. 2A, the speaker 200 and the first microphone 310 are exposed and face outside the body 100.

Reference numeral 410 indicates a first camera that is used to capture an image of a subject (e.g., photograph the subject) where the subject is in a direction which faces the side of the body 100. The body 100 may expose a portion of the first camera 410 such that a view of the subject is not blocked and the image can be captured relatively easily.

As illustrated in FIGS. 1 and 2B, a second microphone 320 and a second camera 420 are provided on the other side of the body 100. The second camera 420 is used to capture an image of a subject (e.g., photograph the subject) where the subject is in a direction which faces the other side of the body 100, and is selectively used according to the first camera 410 and photographing directions. In an unfolded state of the body 100, as shown in FIG. 2B, the second microphone 320 and the second camera 420 are exposed and face outside the body 100.

The second microphone 320 may be used when a user speaks to provide audio signals, in a folded state of the body 100. That is, when the body 100 is folded to be in the folded state thereof, as shown in FIG. 3, the first microphone 310, which was facing outside the body when the body 100 was unfolded, directly faces the speaker 200 at an inside of the folded body 100. If the first microphone 310 in the folded state of the body 100 is used similarly as when the body 100 was unfolded, audio interference may be caused due to sounds from the inside-facing speaker 200 that are directly transferred to the first microphone 310, and accordingly, the user may have difficulty having a phone conversation. Therefore, when the body 100 is folded, the first microphone 310 is turned off (e.g., in an off-state), and the second microphone 320 is turned on (e.g., in an on-state). Since the speaker 200 and the second microphone 320 are not facing each other, and since the second microphone 320 faces outside the body 100, audio interference does not occur, and thus, the user may have a phone conversation without difficulty.

When the body 100 is folded, the second microphone 320 may be disposed to face substantially the same direction as the speaker 200, as illustrated in FIG. 3, or may face a different direction than the speaker 200. In general, since the user calls while having the face near the speaker 200, in order to efficiently transfer sounds, a direction that the second microphone 320 is facing may form 90° or less with respect to a direction A that the inside-facing speaker 200 is facing (that is, the second microphone 320 is facing between direction A and direction B). Accordingly, the user may have a phone conversation without audio interference regardless of whether the body 100 is folded or unfolded.

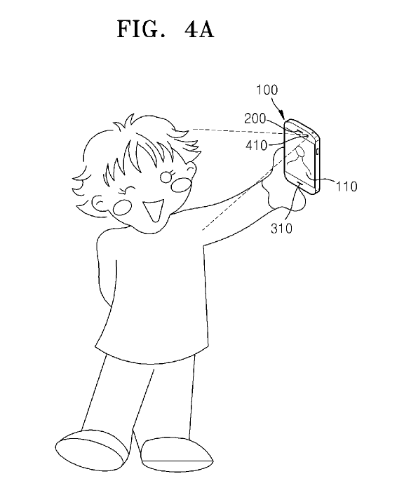

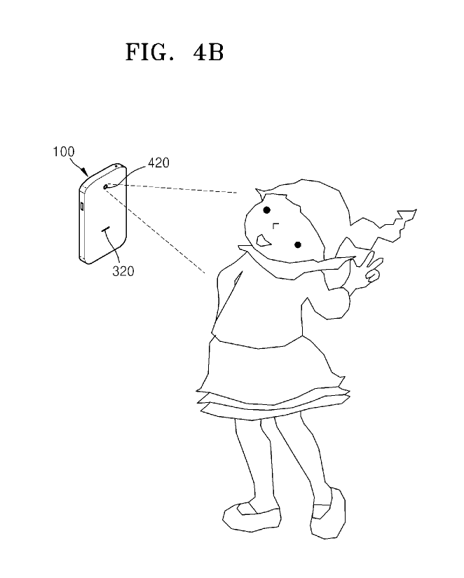

From among the first and second microphones 310 and 320, a microphone that is facing the same direction as a direction faced by either one of the image-capturing first and second cameras 410 and 420 is used. In an exemplary embodiment, for example, when the first camera 410 is used to capture images (refer to FIG. 4A), the first microphone 310 which is provided at the same side of the body 100 as the first camera 410, is turned on. Conversely, in another exemplary embodiment, when the second camera 420 is used to capture images (refer to FIG. 4B), the second microphone 320 which is provided at the same other side of the body 100 as the second camera 420, is turned on. That is, a microphone that is facing a user or subject is used so that audio may be recorded more clearly.

The foldable calling device as described above may be used as below.

First, when the foldable calling device is unfolded, the body 100 is spread out as illustrated in FIG. 1. Each of the display unit 110, the speaker 200, the first and second microphones 310 and 320 and the first and second cameras 410 and 420, is exposed to outside the body 100.

When the body 100 is unfolded, the user provides audio signals to the first microphone 310 and receives audio signals from the speaker 200, which are provided at side of the body 100, such as to have a phone conversation. In this case, the first microphone 310 is in an on-state and the second microphone 320 is in an off-state.

Alternatively, when the body 100 is folded as in FIG. 3, such as to allow a user to easily carry the foldable calling device, the user uses the second microphone 320 and the speaker 200, which are accessible at the other side of the body 100 defined in the unfolded state of the body 100, to have a phone conversation. That is, the user provides audio signals to the second microphone 320 and receives audio signals from the speaker 200. In this case, the second microphone 320 is in an on-state, and the first microphone 310 is in an off-state.

Therefore, in one or more exemplary embodiment according to the invention, call quality may not be decreased due to audio interference, by selectively using the first and second microphones 310 and 320 as described above. The speaker may be in an on-state whether the first or second microphones 310 and 320 are in an on state or an off state.

In addition, in one or more exemplary embodiment according to the invention, when using the first and second cameras 410 and 420 to capture images, the first and second microphones 310 and 320 may be selectively used to increase recording quality. That is, when the first camera 410 is used to capture images as illustrated in FIG. 4A, the first microphone 310 which is provided at the same side of the body 100 as the first microphone 310, is turned on, Here, the second microphone 320 may be turned off, but the invention is not limited thereto. Conversely, when the second camera 420 is used to capture images as illustrated in FIG. 4B, the second microphone 320 which is provided at the same other side of the body 100 as the second camera 420, is turned on. Here, the first microphone 310 may be turned off, but the invention is not limited thereto. Accordingly, since microphones are selectively used according to whether or not a microphone is facing the subject, audio may be recorded more clearly.

As described above, according to one or more of the above-described exemplary embodiments of the invention, a user may use a foldable calling device to conveniently make a call whether the foldable calling device is in a folded state or in an unfolded state, and thus, it is possible to provide a portable and user-convenient device to the user.

It should be understood that the exemplary embodiments described herein should be considered in a descriptive sense only and not for purposes of limitation. Descriptions of features within each exemplary embodiment should typically be considered as available for other similar features in other exemplary embodiments.

While one or more exemplary embodiments of the invention have been described with reference to the figures, it will be understood by those of ordinary skill in the art that various changes in form and details may be made therein without departing from the spirit and scope of the invention as defined by the following claims.

What is claimed is:

1. A foldable calling device comprising:
a body which is foldable;
a speaker at a first side of the body, in an unfolded state of the body;
a first microphone at the first side of the body, in the unfolded state of the body; and
a second microphone at a second side of the body opposite to the first side, in the unfolded state of the body.

2. The foldable calling device of claim 1, wherein in a folded state of the body, the first microphone faces the speaker.

3. The foldable calling device of claim 1, wherein in a folded state of the body, the second microphone is disposed such that a direction that the second microphone is facing forms 90° or less with respect to a direction that the speaker is facing.

4. The foldable calling device of claim 1, wherein
in the unfolded state of the body, the first microphone is in an on state, and
in a folded state of the body, the second microphone is in an on state.

5. The foldable calling device of claim 1, further comprising:
a first camera at the first side of the body, and
a second camera at the second side of the body.

6. The foldable calling device of claim 5, wherein
when the first microphone is in an on state, the first camera is in an on-state, and
when the second microphone is in an on state, the second camera is in an on state.

7. The foldable calling device of claim 1, wherein the body comprises a flexible display panel comprising a display unit.

8. The foldable calling device of claim 7, wherein in the unfolded state of the body,
the speaker is at an upper portion of the display unit, and
the first microphone is at a lower portion of the display unit.

9. A method of providing audio signals to and receiving audio signals from a foldable calling device, comprising:
turning on a first microphone disposed in a foldable body of the foldable calling device, in an unfolded state of the body, and
turning on a second microphone, disposed in the foldable body of the foldable calling device, in a folded state of the body,
wherein the foldable calling device comprises:
a speaker at a first side of the body, in the unfolded state of the body;
the first microphone at the first side of the body, in the unfolded state of the body; and
the second microphone at a second side of the body opposite to the first side, in the unfolded state of the body.

10. The method of claim 9, wherein
when one of the first and second microphones is turned on, the other of the first and second microphones is turned off.

11. The method of claim 9, wherein
the foldable calling device further comprises:
a first camera at the first side of the body, in the unfolded state of the body; and
a second camera at the second side of the body, in the unfolded state of the body,
when the first microphone is turned on, the first camera is in turned on, and
when the second microphone is turned on, the second camera is turned on.

12. The method of claim 9, wherein
the body comprises a flexible display panel comprising a display unit, and
in the unfolded state of the body,
the speaker is at an upper portion of the display unit, and
the first microphone is at a lower portion of the display unit.

13. The method of claim 9, wherein the speaker turned on, in both the unfolded and folded states of the body.
